(19) United States
(12) Patent Application Publication
(10) Pub. No.: US 2026/0036831 A1
(43) Pub. Date: Feb. 5, 2026

(54) EYEWEAR

(71) Applicant: JINS HOLDINGS Inc., Gunma (JP)

(72) Inventor: Keiichi ASADA, Gunma (JP)

(73) Assignee: JINS HOLDINGS Inc., Gunma (JP)

(21) Appl. No.: 19/282,175

(22) Filed: Jul. 28, 2025

(30) Foreign Application Priority Data
Jul. 31, 2024 (JP) 2024-124204

(51) Int. Cl. G02C 5/20

(52) U.S. Cl. CPC G02C 5/20

(57) ABSTRACT

There is provided eyewear equipped with a temple length adjustment mechanism, including: a lens frame; a temple with a female thread having a rear opening opposite a front end connected to the lens frame via a hinge; a temple tip with an insertion hole for forward and backward movement in an extending direction of the temple; a coil spring that applies a spring force between the temple and the temple tip by being contained in the insertion hole; and an adjustment screw to adjust containment length so the rear end portion of the temple is contained in the insertion hole when a shank is pushed into the insertion hole with the shank penetrating the coil spring, a male thread part is screwed into the female thread part, and a threading amount between the male thread part and the female thread part is adjusted.

### BACKGROUND OF THE INVENTION

### Field of the Invention

The present invention relates to eyewear.

### Description of the Related Art

Various contrivances have been proposed to make eyewear fit the heads of wearers so that the wearers can comfortably wear the eyewear typified by eyeglasses. For example, nose pads differing in size are made interchangeable or a mechanism for making temple tips pivotal with respect to temples is provided. As one of these contrivances, a mechanism has been proposed that allows temple length to be adjusted by moving the temple tips forward and backward with respect to the temples (see, for example, Patent Literature 1).

### CITATION LIST

### Patent Literature

Patent Literature 1: Japanese Patent Laid-Open No. 1-129230

Generally, the best method for making eyewear fit the heads of wearers is to go to an eyeglass store and have expert staff make adjustments, but some eyewear is adjustable by wearers themselves as with the eyewear disclosed in Patent Literature 1. However, whether the eyewear has to be adjusted by expert staff or the eyewear can be adjusted by wearers themselves, it is usually the case that adjustments are made by checking for fit by putting on and taking off the eyewear, and such a task involves difficult fine adjustments even if the wearer is an adult. In particular, if the eyewear is worn by a preschool child, to begin with, it is difficult for the child, who is the wearer, to explain the fit in words, and an adult has to make fine adjustments by visually checking the fit by putting on and taking off the eyewear repeatedly.

In the case of eyewear for children, in addition to the challenge of making the eyewear just fit the head, there is the challenge of attaching such mechanisms to the eyewear as to respond to demand from parents and the like to continue using the eyewear by keeping pace with the growth of the children or to allow the children to wear the eyewear safely. For example, the eyewear disclosed in Patent Literature 1 adopts a mechanism for extending temple length by pushing back a sidebar (temple) pressed against an earpiece (temple tip) by a spring, where the sidebar is pushed back from a rear-end side using a fixing screw. However, the mechanism requires that a female thread part be provided in a narrow rear end portion of the temple tip, inevitably reducing total length of the female thread part. Regarding the fixing screw screwed into the female thread part, either a set screw without a screw head is adopted in order not to protrude from the rear end of the temple tip or the screw head or shank is permitted to protrude from the rear end of the temple tip. There is a problem in that in the former case, adjustment of the temple length is restricted to a limited range while in the latter case the protruding screw head might damage the head of the wearer.

The present invention has been made to solve the above problem and provides eyewear equipped with a temple length adjustment mechanism to respond to demand from parents and the like, including demand to make the eyewear just fit the head so simply that there will be no need to put on and take off the eyewear, for example, in making adjustments, or when the eyewear is worn by children, in particular, demand to continue using the eyewear by keeping pace with the growth of the children or to allow the children to wear the eyewear safely.

### SUMMARY OF THE INVENTION

Eyewear according to one aspect of the present invention includes: a lens frame; a temple provided with a female thread part having an opening in a rear end opposite a front end connected to the lens frame via a hinge; a temple tip provided with an insertion hole that enables relative forward and backward movement in an extending direction of the temple when a rear end portion including the rear end of the temple is pushed in; a coil spring that applies a spring force between the temple and the temple tip by being contained in the insertion hole; and an adjustment screw configured to adjust containment length by which the rear end portion of the temple is contained in the insertion hole when a shank is pushed into the insertion hole with the shank penetrating the coil spring, a male thread part is screwed into the female thread part, and a threading amount between the male thread part and the female thread part is adjusted.

The present invention can provide eyewear equipped with a temple length adjustment mechanism to respond to demand from parents and the like, including demand to make the eyewear just fit the head simply, or when the eyewear is worn by children, in particular, demand to continue using the eyewear by keeping pace with the growth of the children or to allow the children to wear the eyewear safely.

### BRIEF DESCRIPTION OF THE DRAWINGS

FIG. 1 is an overall perspective view of eyewear equipped with a temple length adjustment mechanism according to an embodiment of the present invention;

FIG. 2 is an exploded perspective view of the adjustment mechanism used to adjust temple length;

FIG. 3 is an A-plane sectional view in FIG. 1, showing the longest state and shortest state of a temple;

FIG. 4 is an overall perspective view of a temple;

FIG. 5 is an overall perspective view of a temple tip; and

FIG. 6 is a side view of the eyewear.

### DETAILED DESCRIPTION OF THE INVENTION

The present invention will be described below with reference to an embodiment, but the invention set forth in the claims is not limited to the embodiment described below. Besides, all the components described in the embodiment are not necessarily essential as means of solving the problem. Note that components denoted by the same reference signs have identical or similar configurations. For the sake of brevity, reference signs of components the same as or similar to already described components may be omitted even in different embodiments.

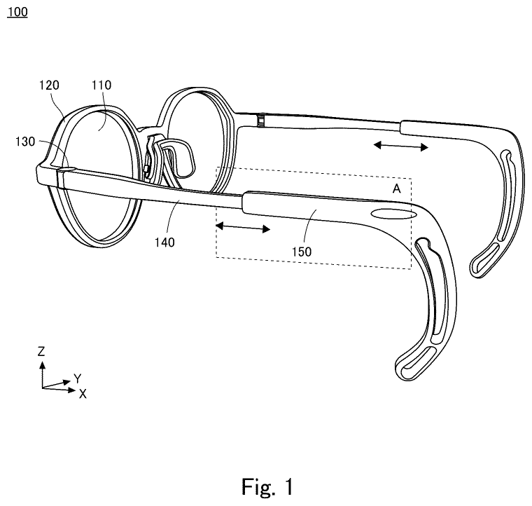

FIG. 1 is an overall perspective view of eyewear 100 equipped with a temple length adjustment mechanism according to an embodiment of the present invention. As with typical eyewear, the eyewear 100 includes lenses 110, a lens frame 120, hinges 130, temples 140, and temple tips 150. The lens frame 120 supports the lenses 110. The hinges 130 connect the temples 140 to the lens frame 120, allowing the temples 140 to be folded onto the lens frame 120. The temple tips 150 are ear hooks to be put on the ears of the wearer and are provided by being connected to the temples 140.

The eyewear 100 according to the present embodiment includes the temple length adjustment mechanism, used to adjust temple length, provided in a connection between the temple 140 and temple tip 150. The temple length adjustment mechanism allows the eyewear 100 to move the temple tip 150 forward and backward relative to the temple 140 within a certain range as indicated by an arrow in FIG. 1.

Note that according to the present embodiment, as indicated by coordinate axes in FIG. 1, the extending direction of the temple 140 is defined as an X-axis direction, the arranging direction of the two lenses 110 is defined as a Y-axis direction, and the direction orthogonal to the X-axis direction and the Y-axis direction is defined as a Z-axis direction. In the following drawings, similar coordinate axes based on a state in which the eyewear 100 is placed as shown in FIG. 1 are illustrated as well, to indicate orientations of structures shown in each drawing. In particular, the positive X-axis direction, the negative X-axis direction, the positive Z-axis direction, and the negative Z-axis direction may be designated as a “rearward” direction, a “forward” direction, an “upward” direction, and a downward direction, respectively. Besides, of the Y-axis direction, the side on which the head of the wearer is located by being sandwiched between the two opened temples 140 may be designated as an “inner” side, and the opposite side may be designated as an “outer” side.

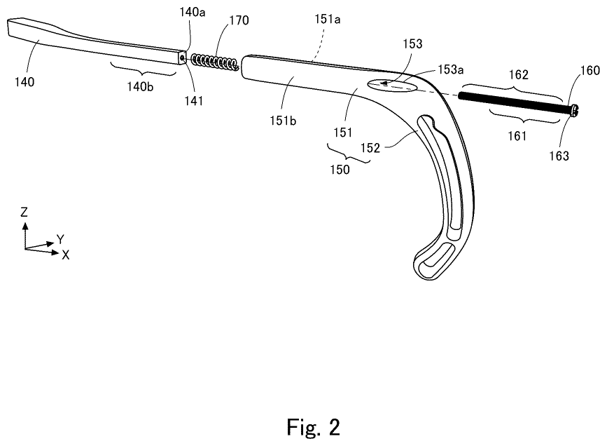

Next, a configuration of the temple length adjustment mechanism will be described. FIG. 2 is an exploded perspective view of the temple length adjustment mechanism. In particular, FIG. 2 shows the temple length adjustment mechanism provided between the temple 140 and the temple tip 150 of the eyewear 100 on the side of the left ear. The temple length adjustment mechanism is provided spanning between the temple 140 and the temple tip 150 and includes an adjustment screw 160 and a coil spring 170 in addition to the temple 140 and the temple tip 150.

The temple 140 is equipped with a female thread part 141 that has an opening in a rear end face 140a at a rear end opposite a front end connected to the hinge 130. The female thread part 141 has a screw thread along the X-axis direction in a rear end portion 140b that includes the rear end.

The temple tip 150 mainly includes an extending portion 151 that is put on an upper part of the wearer's ear by extending along the extending direction of the temple 140, and a bend 152 that extends by bending downward from a rear end portion of the extending portion 151 and runs along the wearer's ear back. The extending portion 151 is provided with an insertion hole 153 that enables relative forward and backward movement in the X-axis direction when the rear end portion 140b of the temple 140 is pushed in. More specifically, the insertion hole 153 is a through-hole that penetrates the extending portion 151 in the X-axis direction almost along the entire length of the extending portion 151.

According to the present embodiment, the rear end portion of the extending portion 151 is made up of a bent surface and a rear opening of the insertion hole 153 is provided such that entire part of a rear opening edge 153a, which is an opening edge of the insertion hole 153, will appear on the side of an outer side face 151b located opposite an inner side face 151a that faces the wearer's head. In other words, the rear opening edge 153a does not appear on the inner side face 151a. In this way, as the rear opening is provided such that the rear opening edge 153a will not appear on the inner side face 151a, when the wearer has the temple length adjusted with the eyewear 100 put on, the chance of hitting the wearer's head with the tip of a screw driver can be reduced when an adjuster pushes the screw driver into the rear opening as described later. In particular, when the wearer is a child, the wearer sweats easily as a result of exercise or the like, causing sweat to enter the insertion hole 153 and resulting in accumulation of dirt, and thus desirably the rear opening edge 153a is provided on the side of the outer side face 151b. Note that according to the present embodiment, although the rear opening edge 153a is provided on the outer side face 151b made up of a bent surface, depending on the design of the temple tip 150, the rear opening edge 153a may be provided, for example, on an upper side face or in an area ranging from the upper side face to the outer side face.

More specifically, the bend 152 extends downward by bending from the lower part of the rear opening edge 153a. As the bend 152 is extended in this way, the rear opening edge 153a is located almost near the rear end of the extending portion 151. When the rear opening edge 153a is located almost at the rear end of the extending portion 151, it is easy for the adjuster to push the tip of the screw driver into the rear opening with the eyewear 100 put on the wearer and easy to adjust the temple length. Note that various designs are conceivable for eyewear equipped with a temple length adjustment mechanism, and thus the arrangement of the bend is not limited to the one described above, and a temple tip without a bend may be adopted.

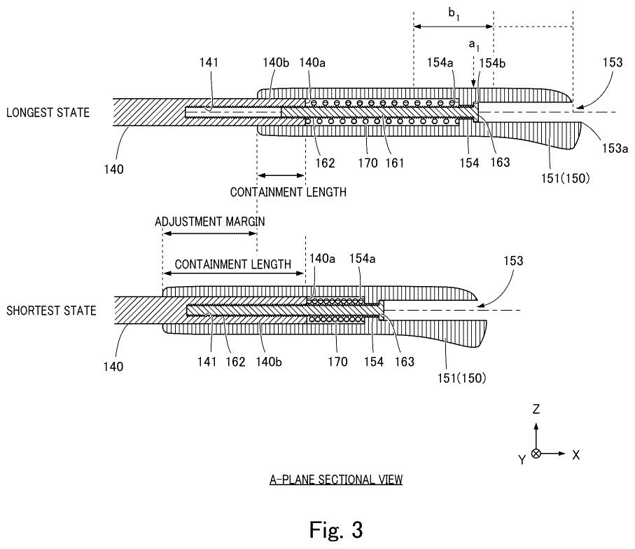

The coil spring 170 is entirely contained in the insertion hole 153. Although a concrete description will be given later, the coil spring 170 functions as a compression spring adapted to urge the temple tip 150 in a direction away from the temple 140. The adjustment screw 160 includes a shank 161, a male thread part 162, and a screw head 163. According to the present embodiment, the adjustment screw 160 is a fully threaded screw in which the male thread part 162 covers the shank 161 as well, but may be a partially threaded screw in which the male thread part 162 is provided only to the extent of being screwed into the female thread part 141. In the case of a partially threaded screw, that part of the shank 161 which is located on the side of the screw head 163 and in which no male thread part 162 is provided may be equal in length to the part not screwed into the female thread part 141 when the male thread part 162 is screwed into the female thread part 141 to a maximum extent (the state shown in the lower part of FIG. 3 described later). The adjustment screw 160 is pushed into the insertion hole 153 through the rear opening with the shank 161 penetrating the coil spring 170 that is contained in the insertion hole 153, and a front end part of the male thread part 162 is screwed into part of the female thread part 141 of the temple 140. If the adjustment screw 160 is a partially threaded screw, the screw thread does not come into contact with the inner side face of the coil spring 170, and thus wear on the coil spring 170 can be reduced.

The temple length adjustment mechanism according to the present embodiment adjusts the temple length according to the length by which the male thread part 162 is screwed into the female thread part 141. FIG. 3 is an A-plane sectional view in FIG. 1, showing the longest state and shortest state of the temple. Specifically, the upper part of FIG. 3 shows the longest state in which the temple length becomes the longest with thread engagement length between the female thread part 141 and the male thread part 162 reduced to the minimum, and the lower part of FIG. 3 shows the shortest state in which the temple length becomes the shortest with the thread engagement length between the female thread part 141 and the male thread part 162 increased to the maximum.

The insertion hole 153 has a restriction portion 154 provided therein, and the restriction portion 154 restricts the position of the screw head 163 of the adjustment screw 160. Specifically, inside the insertion hole 153, the restriction portion 154 is provided as a partition wall including a through-hole that stops the screw head 163 while passing the shank 161 of the adjustment screw 160. Note that according to the present embodiment, an orthogonal section (YZ section) of a front-side cylindrical space is rectangular in sectional shape as described later and an orthogonal section of a rear-side cylindrical space is circular in sectional shape, where the front-side cylindrical space and the rear-side cylindrical space are partitioned by the restriction portion 154.

The restriction portion 154 restricts the position of the adjustment screw 160 and partitions the space in which the coil spring 170 is contained. Specifically, the coil spring 170 is contained in the front-side cylindrical space of the insertion hole 153 with its rear end placed in contact with a spring resting surface 154a, which is a front wall of the restriction portion 154 and with its front end placed in contact with the rear end face 140a of the temple 140. The coil spring 170 is a compression spring. When contained in the front-side cylindrical space of the insertion hole 153, the coil spring 170 always urges the spring resting surface 154a and the rear end face 140a by applying urging forces in such directions as to space the temple 140 and the temple tip 150 away from each other.

When the tip of the male thread part 162 of the adjustment screw 160 is screwed into part of the female thread part 141, the position of the screw head 163 is established with respect to the rear end face 140a of the temple 140. As an abutment surface 154b of the restriction portion 154 urged by the coil spring 170 is pressed against the screw head 163, the temple tip 150 can maintain a stable rest state with respect to the temple 140. In so doing, the rear end portion 140b of the temple 140 remains pushed in the insertion hole 153 over the entire containment length as illustrated.

A threading amount of the male thread part 162 with respect to the female thread part 141 is adjusted by turning the adjustment screw 160 using a screw driver pushed in through the rear opening. In so doing, the larger the threading amount, the more the rear end portion 140b of the temple 140 is housed in the insertion hole 153, and consequently, the temple length, which is the total length of the temple 140 including the temple tip 150 becomes shorter. For example, if the threading amount is increased until the coil spring 170 is compressed to the maximum, the containment length of the rear end portion 140b is maximized and the temple length is reduced to the minimum (the state shown in the lower part of FIG. 3). Conversely, when the threading amount is kept to a minimum, the containment length of the rear end portion 140b is minimized and the temple length is increased to the maximum (the state shown in the upper part of FIG. 3). Therefore, a difference in the containment length of the rear end portion 140b between when the temple length is maximized and when the temple length is minimized is an adjustment margin of the temple length.

The minimum threading amount can be determined to be an amount that allows the temple tip 150 to maintain a stable rest state without wobbling with respect to the temple 140. Thus, preferably the rear end portion 140b fits accurately into the insertion hole 153 and the adjustment screw 160 has high rigidity. The adjustment screw 160, which is inserted into the insertion hole 153 provided in the temple tip 150, preferably has a small diameter such as M1.2 or M1.4. Furthermore, when eyewear for children is assumed, in particular, desirably a long adjustment margin is provided to keep pace with the growth of the children and preferably the total length of the adjustment screw 160 is relatively long and the rigidity is high. A lot of light-weight resin-made eyewear is observed in these days, and in this case, a resin-molded screw is suitable as the adjustment screw 160. If a resin-molded adjustment screw 160 is adopted for the female thread part 141 of the temple 140 made of resin, wear on the thread of the female thread part 141, which poses a problem in continued use, can be reduced more greatly than when an adjustment screw 160 made of metal is adopted. Even in the case of a resin-molded screw, a screw made of super engineering plastics such as PEEK resin relatively high in rigidity is preferable.

Since the adjustment screw 160 is turned by a screw driver pushed in through the rear opening as described above, in order to make it easy for the adjuster to perform the task, preferably the tip of the screw driver can be pushed into the insertion hole 153 to some extent. Thus, according to the present embodiment, of the restriction portion 154, the position (the position indicated by al in the upper part of FIG. 3) of the abutment surface 154b that comes into contact with the screw head 163 is provided in a range (the range indicated by bl in the upper part of FIG. 3) of 5 mm (inclusive) to 10 mm (exclusive) from the rear opening of the insertion hole 153. Note that the position of the rear opening is, for example, at an intersection between a central axis of the insertion hole 153 and the rear opening edge 153a.

Note that according to the present embodiment, as described above, the coil spring 170 is a compression spring, that applies urging forces in such directions as to space the temple 140 and the temple tip 150 away from each other. If a compression spring is adopted as the coil spring 170, adjustments can be made easily with the eyewear 100 put on the wearer. That is, the adjuster can set the temple 140 longer than an optimal length at first, tighten the adjustment screw 160 gradually until the bend 152 of the temple tip 150 fits the wearer's ear back, and thereby adjust the temple 140 to the optimal length. The adjustment technique for tentatively making a loose fit on the ear and then gradually achieving a snug fit in this way is effective not only when the wearer is an adult, but also, in particular, when the wearer is a child for whom it is difficult to explain a comfortable fit to the adjuster in words. On the other hand, another configuration in which the coil spring is a tension spring may be adopted in response to other demand. When such a configuration is adopted, anchors may be provided, for example, on the rear end face 140a and the spring resting surface 154a, respectively, to anchor respective ends of the tension spring.

Such an adjustment mechanism adapted to adjust the temple length allows a relatively long female thread part 141 (with a large number of thread crests) to be provided in the rear end portion 140b of the temple 140 and allows an adjustment screw 160 with an accordingly long male thread part 162 (with a large number of thread crests), making it possible to achieve a longer adjustment margin than a conventional mechanism. Therefore, for example, when worn by a child, the eyewear 100 can be continued to be used for a certain period by keeping pace with the growth of the child. Note that generally, the positions of the left and right ears are not symmetrical and there is a slight offset, and thus if the left and right temples can be adjusted using separate adjustment screws 160, a fit to the head can be improved. Besides, since the screw head 163 does not protrude from the rear opening edge 153a of the insertion hole 153, there is no fear that the head of the wearer will be damaged. That is, the eyewear 100 can be worn safely.

As described above, the temple length adjustment mechanism according to the present embodiment realizes adjustment of the temple length as follows: the rear end portion 140b of the temple 140 is pushed into the insertion hole 153 in the temple tip 150 and the adjustment screw 160 is turned, thereby enabling relative forward and backward movement along the extending direction of the temple 140. With the eyewear 100 that adopts the adjustment mechanism described above, from the viewpoint of ease-of-adjustment in a worn state and stability during use, preferably the temple tip 150 does not rotate around the extending direction of the temple 140. Thus, with the eyewear 100 according to the present embodiment, the rear end portion 140b of the temple 140 and the front-side cylindrical space of the insertion hole 153 are formed into non-circular shapes similar to each other in sectional shape of orthogonal section with respect to the extending direction such that the rear end portion 140b will loosely fit in the front-side cylindrical space without rotation around the extending direction.

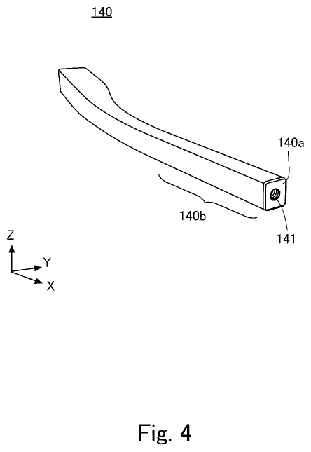

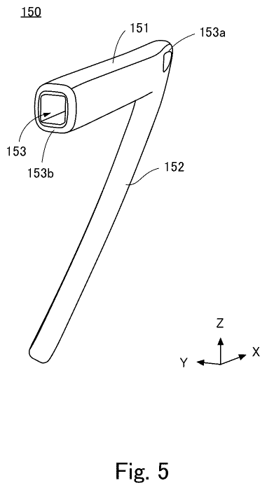

FIG. 4 is an overall perspective view of the temple 140 as viewed from a rear-end side. As illustrated, the rear end portion 140b of the temple 140 takes on a rectangular shape as the sectional shape of the orthogonal section with respect to the extending direction. FIG. 5 is an overall perspective view of the temple tip 150 as viewed from a front-end side. As illustrated, of the insertion hole 153 provided in the temple tip 150, the cylindrical space (the front-side cylindrical space partitioned by the restriction portion 154) continuing from a front opening surrounded by a front opening edge 153b takes on a rectangular shape, which is similar to the rectangular shape of the rear end portion 140b of the temple 140, as the sectional shape of the orthogonal section with respect to the extending direction. In this way, the front-side cylindrical space and the rear end portion 140b of the temple 140, which are rectangular in sectional shape, can move forward and backward in the extending direction by fitting together, but are restrained from rotation around the extending direction. Available configurations are not limited to the one in which the mating parts have non-circular shapes similar to each other in sectional shape of orthogonal section, and it is sufficient if the temple tip does not rotate around the extending direction of the temple. For example, a raised rail and a recessed guide that are engaged with each other and run in the extending direction may be provided on one and the other of the rear end portion 140b and the front-side cylindrical space of the insertion hole 153.

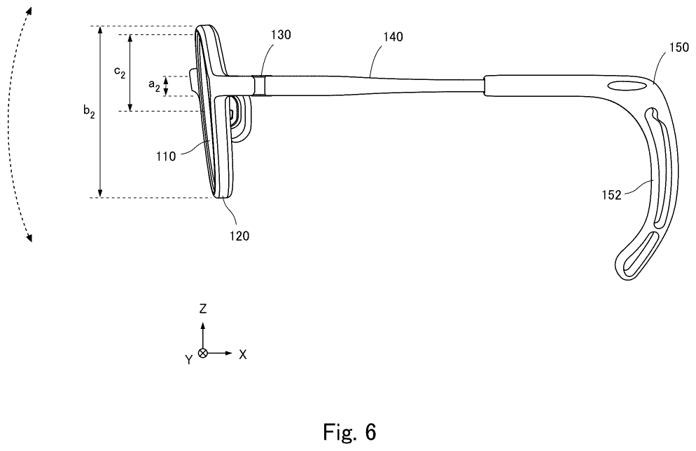

FIG. 6 is a side view of the eyewear 100. As described above, the temple tip 150 includes the bend 152, and by adjusting the temple length appropriately, the bend 152 of the temple tip 150 can be caused to fit the wearer's ear back. However, even if the bends 152 are caused to fit the ear backs with much effort, if, for example, the lenses 110 are heavy and the whole eyewear 100 is poorly balanced, the eyewear 100 can get out of alignment in a pitching direction indicated by the dotted arrow while in use.

As with the eyewear 100 according to the present embodiment, in order to maintain the balance of the whole eyewear 100 even when the temple length is extended or shortened using the adjustment mechanism, it is important to appropriately select the positions of the hinges 130 with respect to the lens frame 120. After repeating trials, the present inventor has found that preferably the placement locations (location indicated by a2 in FIG. 6) of the hinges 130 are set to fall within a range (range indicated by c2 in FIG. 6) of 5% (inclusive) to 50% (exclusive) from the top in the vertical direction of the lens frame 120 (range indicated by b2 in FIG. 6). If the hinges 130 are placed in this range, even if the temple length is changed by the adjustment mechanism, it is easy to maintain a state in which the eyewear just fits the wearer's head.

Note that with the eyewear 100 according to the present embodiment, the lens frame 120 that supports peripheries of the lenses 110 is assumed, but, for example, if the lens frame is provided only along upper parts of the lenses and lower parts of the lenses are supported by a wire extending from the lens frame, the range indicated by b2 in FIG. 6 is a range defined by the lens frame and the wire.

In the present embodiment described above, for example, the extending direction of the temple 140 has been described as being the X-axis direction, but actual eyewear can be designed using an aggregate of complicated three-dimensional curved surfaces and segment elements by assuming the head of the wearer. Even such eyewear can incorporate an adjustment mechanism similar to the adjustment mechanism of the eyewear 100. The eyewear incorporating the adjustment mechanism is applicable not only to eyewear for children, but also to eyewear for adults. For example, when a single set of eyewear is used by two or more persons, the temple length can be adjusted to the head of each wearer. Besides, the adjustment mechanism can be applied not only to eyeglasses, but also to MR (mixed reality) glasses and the like.

### REFERENCE SIGNS LIST

100: eyewear; 110: lens; 120: lens frame; 130: hinge; 140: temple; 140a: rear end face; 140b: rear end portion; 141: female thread part; 150: temple tip; 151: extending portion; 151a: inner side face; 151b: outer side face; 152: bend; 153: insertion hole; 153a: rear opening edge; 153b: front opening edge; 154: restriction portion; 154a: spring resting surface; 154b: abutment surface; 160: adjustment screw; 161: shank; 162: male thread part; 163: screw head; 170: coil spring

1. Eyewear comprising:
a lens frame;
a temple provided with a female thread part having an opening in a rear end opposite a front end connected to the lens frame via a hinge;
a temple tip provided with an insertion hole that enables relative forward and backward movement in an extending direction of the temple when a rear end portion including the rear end of the temple is pushed in;
a coil spring that applies a spring force between the temple and the temple tip by being contained in the insertion hole; and
an adjustment screw configured to adjust containment length by which the rear end portion is contained in the insertion hole when a shank is pushed into the insertion hole with the shank penetrating the coil spring, a male thread part is screwed into the female thread part, and a threading amount between the male thread part and the female thread part is adjusted.

2. The eyewear according to claim 1, wherein an opening edge of a rear opening on a side of the insertion hole which is communicated with a screw head of the adjustment screw is provided on a side face of the temple tip which is different from an inner side face that faces a head of a wearer.

3. The eyewear according to claim 2, wherein the temple tip includes a bend that extends by bending from a lower part of the opening edge and runs along an ear back of the wearer.

4. The eyewear according to claim 3, wherein the hinge is provided at a location falling within a range of 5% (inclusive) to 50% (exclusive) from a top in a vertical direction of the lens frame.

5. The eyewear according to claim 1, wherein the insertion hole includes a restriction portion adapted to restrict a position of a screw head of the adjustment screw, and a contact position of the restriction portion that comes into contact with the screw head is provided in a range of 5 mm (inclusive) to 10 mm (exclusive) from a rear opening of the insertion hole.

6. The eyewear according to claim 1, wherein the rear end portion is pushed into the insertion hole to keep the temple tip from rotating around the extending direction of the temple.

7. The eyewear according to claim 1, wherein the coil spring is a compression spring placed between the temple and the temple tip and adapted to urge the temple tip in a direction away from the temple.
